(19) United States
(12) Patent Application Publication
(10) Pub. No.: US 2019/0047186 A1
(43) Pub. Date: Feb. 14, 2019

(54) OPTICAL SHEET FORMING APPARATUS AND OPTICAL SHEET FORMING METHOD

(71) Applicant: TOSHIBA KIKAI KABUSHIKI KAISHA, TOKYO (JP)

(72) Inventors: Koji MIZUNUMA, Sunto-gun (JP); Daichi YUKAWA, Sunto-gun (JP); Yuta YAMAMURO, Numazu-shi (JP)

(73) Assignee: TOSHIBA KIKAI KABUSHIKI KAISHA, TOKYO (JP)

(21) Appl. No.: 16/163,045

(22) Filed: Oct. 17, 2018

Related U.S. Application Data
(63) Continuation of application No. PCT/JP2017/014588, filed on Apr. 7, 2017.

(30) Foreign Application Priority Data
Apr. 27, 2016 (JP) 2016-089540

(51) Int. Cl. B29C 43/02; B29C 47/88; B29C 47/92; B29C 47/16

(52) U.S. Cl. CPC B29C 43/021; B29C 47/16; B29C 47/92; B29C 47/88

(57) ABSTRACT

An optical sheet forming technique includes an extrusion unit having a discharge slit, a forming roll unit having rolls rotatable about rotation axes, a thick portion forming groove provided in the forming roll unit, and a position adjustment mechanism which adjusts a position of a discharge slit with respect to the thick portion forming groove. In a discharged molten resin, a neck-in portion caused by a neck-in phenomenon is continuously formed in an extrusion direction. The neck-in portion is positioned to be opposed to the thick portion forming groove by the position adjustment mechanism.

### CROSS-REFERENCE TO RELATED APPLICATIONS

This application is a Continuation Application of PCT Application No. PCT/JP2017/014588, filed Apr. 7, 2017 and based upon and claiming the benefit of priority from prior Japanese Patent Application No. 2016-089540, filed Apr. 27, 2016, the entire contents of all of which are incorporated herein by reference.

### BACKGROUND OF THE INVENTION

### 1. Field of the Invention

The present invention relates to a technique of forming, for example, an optical sheet used for a light guide plate, etc., by extrusion molding. In the embodiments, the light guide plate is formed as a thickness-reduced sheet for optical use (referred to also as a thin sheet).

### 2. Description of the Related Art

For example, in the technical field of mobile devices such as mobile phones and smartphones, along with the trend of thinner device bodies, thinner backlight units are required, accordingly. The backlight unit is composed of, for example, a light guide plate, a diffusion sheet, a prism sheet, etc. The light guide plate is formed of transparent resin having a high refractive index. To reduce the thickness of the backlight unit, a thickness-reduced light guide plate, that is, a thin light guide plate needs to be formed. Therefore, to meet the above-described need, a technique of forming an optical thin sheet using resin has been proposed (for example, see Patent Literature 1 (JP 2014-502568 A)).

As the technique of forming a thin sheet, injection molding and extrusion molding are assumed. In this case, extrusion molding is a technique which is superior to injection molding in productive efficiency. Therefore, a thin resin sheet should preferably be formed by an extrusion molding technique.

### BRIEF SUMMARY OF THE INVENTION

In a conventional extrusion molding technique, in the case of continuously forming a thin sheet having flat front and back surfaces and having a constant thickness (hereinafter referred to as a standard thickness), for example, a technique of continuously forming a thin sheet by thinly spreading and discharging a molten resin extruded from an extruder in a sheet shape through a flow passage of a T die, and compressing and solidifying the discharged sheet-shaped molten resin by a pair of rolls has been known. In this technique, the flow passage of the T die is configured such that the flow volume of the molten resin becomes uniform in the width direction of the T die when the molten resin is thinly spread into a sheet shape.

In the meantime, the technique of continuously forming a thin sheet is not exclusively applied to the formation of a thin sheet having flat front and back surfaces but is also applied to the formation of a patterned sheet having a recess-projection pattern in which recesses and projections are regularly arranged side by side entirely on one or both of the front and back surfaces. In this case, a projection-recess pattern corresponding to the reversed recess-projection pattern of the patterned sheet is provided on the surfaces of the pair of rolls. At this time, similarly to the formation of a thin sheet having flat front and back surfaces, a sheet-shaped molten resin having a uniform volume in the width direction is discharged from the T die. When the sheet-shaped molten resin contacts the pair of rolls, molten resin overflowing from the projections of the pattern sneaks into the recesses of the pattern, and the volume of resin is thereby balanced. Therefore, the average thickness of the formed patterned sheet will be the standard thickness.

On the other hand, in the case of forming a thin sheet having flat front and back surfaces and having the standard thickness, as the contour of a preset shape, for example, it is impossible to stereoscopically project (thicken) a part of the surface of the thin sheet while maintaining the standard thickness.

In this case, only a recessed groove pattern corresponding to the reversed projection (stereoscopically-projected part of the surface) of the thin sheet is provided on the surfaces of the pair of rolls. In other words, a projection corresponding to a recessed groove is not provided on the surfaces of the pair of rolls. Further, similarly to the formation of a thin sheet having flat front and back surfaces, a sheet-shaped molten resin having a uniform volume in the width direction is discharged from the T die.

In that case, when the sheet-shaped molten resin contacts the pair of rolls, the molten resin sneaking effect is not sufficient for the molten resin to sneak into the entire recessed groove of the pattern. That is, it is impossible to sufficiently secure the volume of resin necessary for the stereoscopic projection (thickening). As a result, for example, because of “sink” which occurs when the molten resin solidifies, the thin sheet having the contour of a preset shape cannot be accurately formed in some cases.

The present invention aim to provide an optical sheet forming technique of accurately forming an optical sheet having a contour of a preset shape by extrusion molding.

To achieve the aim, the present invention comprises an extrusion unit having a discharge slit, a forming roll unit having a roll configured to rotate about a rotation axis, a thick portion forming groove provided in the forming roll unit, and a position adjustment mechanism configured to adjust a position of the discharge slit with respect to the thick portion forming groove. A neck-in portion caused by a neck-in phenomenon is continuously formed in the extrusion direction in the molten resin discharged from the discharge slit. The neck-in portion is positioned to be opposed to the thick portion forming groove by the position adjustment mechanism.

According to the present invention, an optical sheet forming technique of accurately forming an optical sheet having a contour of a preset shape by extrusion molding can be realized.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the exterior structure of an optical sheet forming apparatus according to one embodiment.

FIG. 2 is a perspective view showing the exterior structure of a T die.

FIG. 3 is a sectional view showing the interior structure of the T die.

FIG. 4 is a schematic view showing a state where a neck-in portion is located to be opposed to a thick portion forming groove.

FIG. 5 is a schematic view showing a state where the neck-in portion is located to be opposed to the thick portion forming groove by a deckle.

FIG. 6 is a sectional view showing a cutting portion of a half-finished product.

FIG. 7 is a sectional view showing a mode of a finished product as a light guide plate.

FIG. 8 is a sectional view showing the structure of a press roll according to one modification.

FIG. 9 is a sectional view showing a result of comparison between a case where the neck-in portion is opposed to the thick portion forming groove (present invention sample) and a case where the neck-in portion is not opposed to the thick portion forming groove (conventional sample).

### DETAILED DESCRIPTION OF THE INVENTION

One of the embodiments of the present invention will be described hereinafter with reference to the accompanying drawings.

### One Embodiment

“Regarding General Description of Optical Sheet Forming Apparatus”

An optical sheet forming apparatus according to the present embodiment is configured to form a light guide plate. The light guide plate is used as a structure of a backlight unit of a mobile device such as a mobile phone or a smartphone, for example. The light guide plate can be formed of a transparent resin having a high refractive index. As the transparent resin, for example, resin such as acrylic resin (PMMA), polycarbonate resin (PC) and cycloolefin resin (COP) can be applied.

As shown in FIG. 7, a thin light guide plate 1 for optical use comprises a light incident portion 2 and a surface emitting portion 3. The light incident portion 2 is thicker than the surface emitting portion 3. Here, along with the trend of the thin backlight unit, the surface emitting portion 3 needs to be thin. On the other hand, it is technically difficult to make a light source 7 (for example, an LED) which will be described later as thin as the surface emitting portion 3. Therefore, to take in all the light from the light source 7 while further reducing the thickness of the surface emitting portion 3, the light incident portion 2 needs to be at least as thick as the light source 7.

An upper surface 2a of the light incident portion 2 and an upper surface 3a of the surface emitting portion 3 are formed as smooth and flat surfaces. Both of the upper surfaces 2a and 3a are arranged parallel to each other. On the other hand, a lower surface is of the light guide plate 1 is continuously formed from the light incident portion 2 to the surface emitting portion 3. The lower surface is of the light guide plate 1 is formed as a smooth and flat surface. The lower surface Is of the light guide plate 1 is opposed parallel to both of the upper surfaces 2a and 3a.

In the light incident portion 2, a smooth and inclined surface 4 is formed between the upper surface 2a and the upper surface 3a. A boundary portion 5 between the inclined surface 4 and the upper surface 2a of the light incident portion 2 is angular. In other words, the boundary portion 5 between the inclined surface 4 and the upper surface 2a of the light incident portion 2 is not rounded. In short, the angle sharply changes at the boundary portion 5 from the upper surface 2a of the light incident portion 2 toward the inclined surface 4.

The light guide plate 1 is integrally formed from the light incident portion 2 to the surface emitting portion 3. A light incident surface 2b is formed in the light incident portion 2. The light incident surface 2b spreads in a direction orthogonal to the upper surfaces 2a and 3a. The light incident surface 2b has, for example, a rectangular shape. The light incident surface 2b is formed to be directly opposed to the surface emitting portion 3 from the light incident portion 2. A light diffusing component 6 such as a diffusion sheet or a prism sheet, for example, is mounted on the upper surface 3a of the surface emitting portion 3.

Here, the light guide plate 1 with the light diffusing component 6 is installed in the mobile device. The light source 7 (for example, an LED) is arranged to be opposed to the light incident surface 2b. The backlight unit is thereby formed in the mobile device. In this structure, the light emitted from the light source 7 is guided from the light incident surface 2b to the light incident portion 2. The light guided to the light incident portion 2 is guided along the inclined surface 4 and propagates to the surface emitting portion 3 without leakage. The light propagated to the surface emitting portion 3 is diffused planarly by the light diffusing component 6. As a result, uniform light can be generated planarly from the surface emitting portion 3.

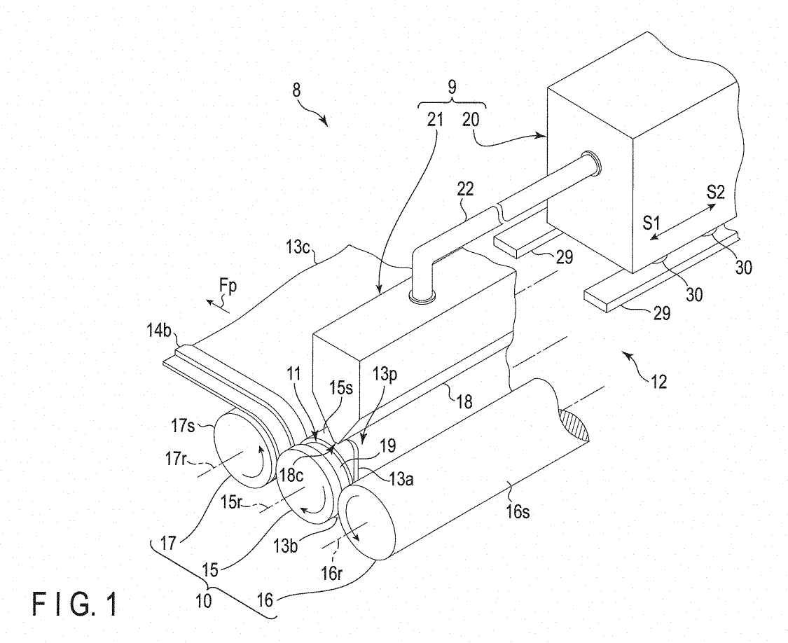

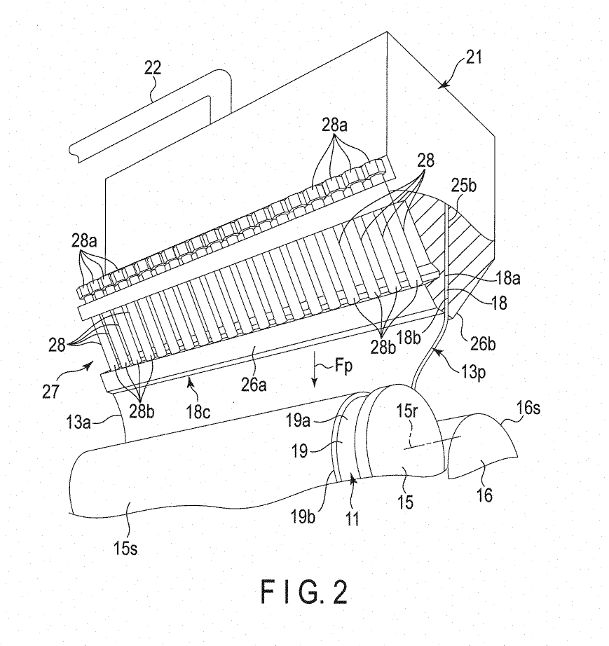

As shown in FIGS. 1 to 3, an optical sheet forming apparatus 8 comprises an extrusion unit 9, a forming roll unit 10, a thick portion forming mechanism 11 and a position adjustment mechanism 12.

The extrusion unit 9 is configured to discharge a sheet-shaped molten resin 13a.

In the forming roll unit 10, the discharged sheet-shaped molten resin 13a changes to a molten resin 13b whose surface alone is solidified. For example, in the case of amorphous resin, the temperature is adjusted to a temperature lower than a glass transition point. After that, an optical sheet 13c which is solidified and is entirely flexible is conveyed in the direction of an arrow Fp.

The thick portion forming mechanism 11 is configured to form a thick portion 14b which is thicker than the other portion continuously in the extrusion direction Fb in the molten resins 13a and 13b.

The position adjusting mechanism 12 is configured to adjust the position of the extrusion unit 9 with respect to the forming roll unit 10.

Here, the extrusion direction Fp indicates, for example, a direction along a series of extrusion pathways which are continuous from the extrusion unit 9 to the forming roll unit 10. The series of extrusion pathways indicates a series of process passages through which the molten resin 13a discharged from the extrusion unit 9 in the gravitational (vertical) direction is sent out through the forming roll unit 10.

“Forming Roll Unit 10”

The forming roll unit 10 comprises a main roll (second roll) 15, a press roll (first roll) 16 and a feed roll (third roll) 17. The three rolls 15, 16 and 17 are formed as temperature-controlled rolls. The three rolls 15, 16 and 17 are maintained at a preset constant temperature. The set temperature indicates a temperature at which the molten resins 13a and 13b are not melted but are solidified and maintained to be flexible. For example, in the case of polycarbonate resin (PC), the temperature is set to 100° C. to 140° C.

The main roll (second roll) 15 has a cylindrical transfer surface 15s. The transfer surface 15s is mirror-finished. The transfer surface 15s is configured to guide the sheet-shaped molten resin 13a discharged from a discharge slit 18 which will be described later in the extrusion direction Fp.

The press roll (first roll) 16 has a cylindrical transfer surface 16s. The transfer surface 16s is mirror-finished. The transfer surface 16s is configured to press the molten resin 13a against the transfer surface 15s of the main roll 15.

The feed roll (third roll) 17 has a cylindrical feed surface 17s. The feed surface 17s is not necessarily mirror-finished. The feed surface 17s is configured to send out the optical sheet 13c in the extrusion direction Fp.

The three rolls 15, 16 and 17 are configured to rotate about single rotation axes 15r, 16r and 17r, respectively. The three rotation axes 15r, 16r and 17r are arranged parallel to each other in the horizontal direction. In other words, the three rotation axes 15r, 16r and 17r are arranged in a direction (horizontal direction) crossing (orthogonally crossing) the gravitational (vertical) direction. The rotation direction of the main roll 15 is set to be opposite to the rotation direction of the other two rolls 16 and 17.

In this structure, the sheet-shaped molten resin 13a discharged from the extrusion unit 9 in the gravitational (vertical) direction passes (a contact point) between the main roll 15 and the press roll 16. While the molten resin 13a which has passed the contact point is being conveyed along the transfer surface 15s of the main roll 15, the molten resin 13a becomes the molten resin 13b whose surface alone is solidified. After the molten resin 13b passed (a contact point) between the main roll 15 and the feed roll 17, the molten resin 13b becomes the optical sheet 13c which is solidified and is entirely flexible. The optical sheet 13c is thereby conveyed in the direction of the arrow Fp. At this time, the thickness of the optical sheet 13c is set as a half-finished product which leads to the thin light guide plate 1.

As an example of the best mode, the drawing shows a mode where the three rolls 15, 16 and 17 are arranged side by side in the horizontal direction. Alternatively, as a relatively preferable mode, for example, the main roll 15 may be centered and the side rolls (the press roll 16 and the feed roll 17) may be obliquely arranged. However, vertical arrangement of the three rolls 15, 16 and 17 in the gravitational (vertical) direction cannot be said as the best mode.

In the vertical arrangement mode, the resin will be discharged from the extrusion unit 9 to (the contact point) between the main roll 15 and the press roll 16.

At this time, before reaching (the contact point) between the main roll 15 and the pushing roll 16, the discharged resin is pulled down and hung down by the action of gravity. Therefore, the resin contacts the lower roll (for example, the press roll 16) first, and solidification starts relatively early. As a result, the transfer (forming) accuracy (between the main roll 15 and the press roll 16 may not be maintained constant.

“Thick Portion Forming Mechanism 11”

The thick portion forming mechanism 11 can be formed in one or both of the main roll 15 and the press roll 16. In this case, the thick portion forming mechanism 11 should preferably be formed in the main roll 15. Therefore, the drawing shows the thick portion forming mechanism 11 formed in the main roll 15 as an example. The thick portion forming mechanism 11 has an annular thick portion forming groove 19 in the circumferential direction of the mail roll 15. The thick portion forming groove 19 is provided on the transfer surface 15s of the main roll 15.

On the transfer surface 15s, the thick portion forming groove 19 is formed to be continuously recessed from the other surface in the circumferential direction. The thick portion forming groove 19 is applied to a mode where a portion (thick portion 14b) which is thicker than the other portion is formed continuously in the extrusion direction Fp in a half-finished product (for example, the optical sheet 13c) which has a constant thickness (standard thickness).

In the present embodiment, a mode of forming one half-finished (thin light guide plate 1) is assumed. In this case, it is only necessary to form one thick portion forming groove 19 (thick portion forming mechanism 11) on one side of the main roll 15 in the width direction. As a result, the thick portion 14b which is thicker than the other portion can be continuously formed in the extrusion direction Fp in the molten resins 13a and 13b which have passed between the main roll 15 and the press roll 16.

“Extrusion Unit 9”

The extrusion unit 9 comprises an extruder 20 and a T die 21. The extruder 20 and the T die 21 are connected to each other through a connection pipe 22. The extruder 20, the connection pipe 22 and the T die 21 are heated to a set temperature in advance and maintained at the set temperature. The set temperature is higher than the set temperature of the three rolls 15, 16 and 17. For example, in the case of polycarbonate resin (PC), the temperature is set to about 260° C.

The extruder 20 comprises a cylinder and a hopper which are not shown in the drawing. One or more screws (not shown) are rotatably inserted in the cylinder. Here, a single screw extruder 20 is provided in a mode where one screw is inserted in the cylinder. A twin screw extruder 20 is provided in a mode where a plurality of (for example, two) screws are inserted in the cylinder.

The hopper is configured to introduce a resin material into the cylinder. Here, for example, a pelletized resin material is introduced from the hopper. The input resin material is melted and kneaded by the rotating screw inside the cylinder. The molten and kneaded resin material is conveyed in a molten state to the distal end of the cylinder. The connection pipe 22 is provided at the distal end of the cylinder.

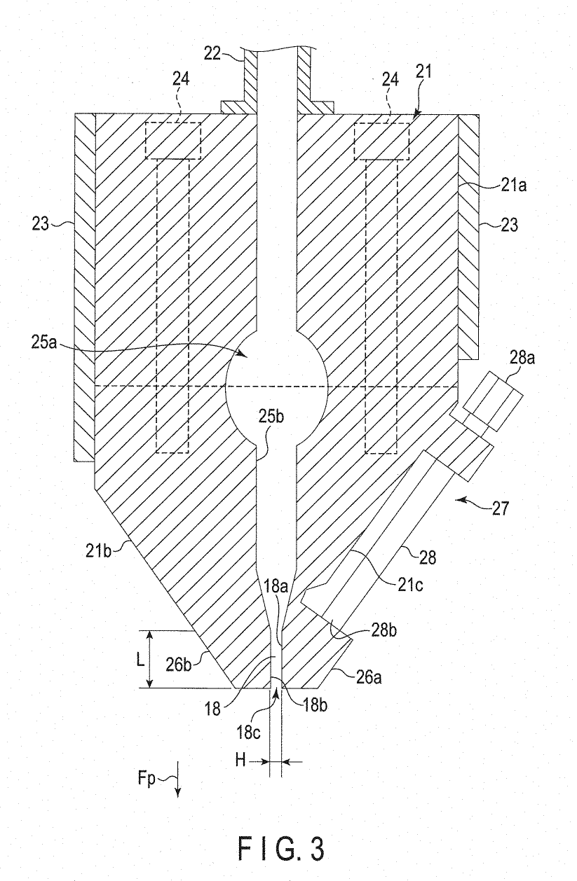

The molten resin conveyed to the distal end of the cylinder is supplied to the T die 21 through the connection pipe 22. In other words, the molten resin is generated in the extruder 20. The generated molten resin is supplied to the T die 21 through the connection pipe 22. A heater 23 which heats the T die and keeps the T die warm (see FIG. 3) is provided in the T die 21. The T die 21 is maintained at a preset constant temperature by the heater 23. Therefore, the molten resin supplied to the T die 21 does not solidify but is maintained in a constant molten state. Since the temperature for maintaining the T die 21 at the constant temperature is set in accordance with the type or application of the molten resin, numerical limitation thereof will not be described in particular.

The T die 21 is configured to spread and discharge the supplied molten resin in a sheet shape. The T die 21 comprises, for example, a manifold 25a which communicates with the connection pipe 22 and a clearance passage 25b which extends from the manifold 25a (see FIG. 3). The manifold 25a extends in a direction crossing the extrusion direction Fp (that is, the width direction of the slit 18 which will be described later). The clearance passage 25b spreads planarly in the width direction of the manifold 25a. One end of the clearance passage 25b is connected to the manifold 25a. The other end of the clearance passage 25b is connected to the slit 18.

The T die 21 comprises a T die body 21a, a fixed lip 21b and a movable lip 21c. The fixed lip 21b and the movable lip 21c can be detachably attached to the T die body 21a by fastening bolts 24. In a state where the fixed lip 21b and the movable lip 21c are attached to the T die body 21a, the manifold 25a and the clearance passage 25b are formed in the T die 21.

“Discharge Slit 18”

The T die 21 comprises the discharge slit 18 (hereinafter referred to as a slit). The slit 18 is configured to discharge the sheet-shaped molten resin 13a. The slit 18 has two slit surfaces (first slit surface 18a and second slit surface 18b) which are opposed parallel to each other). The two slit surfaces (first slit surface 18a and second slit surface 18b) are formed as flat surfaces without recesses and projections.

Here, the slit 18 is defined as a clearance (also referred to as a lip clearance H) between the first slit surface 18a and the second slit surface 18b. The slit 18 is defined in a range over the entire length (flow passage length L (see FIG. 3)) of the first and second slit surfaces 18a and 18b in the extrusion direction Fp. Further, the slit 18 is provided with a discharge port 18c at the distal end thereof.

More specifically, the discharge port 18c is provided at the distal end of the T die 21. The distal end of the T die 21 indicates the lowermost portion corresponding to the lowermost position in the gravitational direction. The discharge port 18c is formed on the end face of the lowermost portion (the lower end faces of the first and second slit surfaces 18a and 18b). Further, the T die 21 is provided with two lips (first lip 26a and second lip 26b) at the distal end thereof. The first lip 26a and the second lip 26b are opposed to each other with a space formed therebetween. The first lip 26a is provided in the movable lip 21c. The second lip 26b is provided in the fixed lip 21b.

The first and second slit surfaces 18a and 18b are provided on the opposing surfaces of the first and second lips 26a and 26b, respectively. That is, the first slit 18a is provided on the opposing surface of the first lip 26a. The second slit surface 18b is provided on the opposing surface of the second lip 26b. In this way, the slit 18 is formed over a clearance region (lip clearance H) between the first slit surface 18a and the second slit surface 18b.

In this structure, the discharge port 18c can be defined as a thin rectangular opening which extends in a direction crossing the extrusion direction Fp (that is, the width direction of the slit 18) along the lower end faces of the first and second slit surfaces 18a and 18b. In this case, the molten resin 13a discharged from the T die 21 (the slit 18 and the discharge port 18c) falls down in a long and thin rectangular shape as a whole. At this time, as will be described later, due to a neck-in phenomenon, necked-in portions 13p are formed continuously in the extrusion direction Fp at both edge portions (both side portions) of the molten resin 13a.

The T die 21 comprises a lip clearance adjustment mechanism 27 configured to adjust the clearance (lip clearance H) between the two lips 26a and 26b (first and second slit surfaces 18a and 18b). The lip clearance adjustment mechanism 27 has a plurality of lip adjustment bolts 28. The lip adjustment bolts 28 are arranged parallel to each other and are evenly spaced apart from each other. The lip adjustment bolts 28 are rotatably supported on the T die 21. An adjustment portion 28a is provided at the proximal end of the lip adjustment bolt 28. A press portion 28b is provided at the distal end of the lip adjustment bolt 28. The press portion 28b is configured to make contact with one of the two lips 26a and 26b.

The drawing shows the lip adjustment bolt 28 in which the press portion 28b makes contact with the first lip 26a as an example. Here, the adjustment portion 28a is rotated. The press portion 28b is advanced. A pressing force is applied from the press portion 28b to the first lip 26a. The first lip 26a is elastically deformed. The first lip 26a is thereby brought close to the second lip 26b. As a result, the lip clearance H can be narrowed.

Conversely, the adjustment portion 28a is rotated in the opposite direction. The press portion 28b is retreated. The pressing force from the press portion 28b to the first lip 26a is canceled. The first lip 26a is restored to an original shape by an elastic force thereof. The first lip 26a is thereby separated from the second lip 26b. As a result, the lip clearance H can be expanded.

“Position Adjustment Mechanism 12”

As shown in FIGS. 1 to 2 and 4, the position adjustment mechanism 12 is configured to move the extrusion unit 9 and the forming roll unit 10 relatively along the rotating axes 15r, 16r and 17r. The position of the slit 18 with respect to the forming roll unit 10 can be thereby adjusted. In this case, as the mode of the position adjustment mechanism 12, the following three variations can be assumed.

In the mode of the first variation, the extrusion unit 9 is moved along the rotation axes 15r, 16r and 17r. In the mode of the second variation, the forming roll unit 10 is moved along the rotation axes 15r, 16r and 17r. In the mode of the third variation, both the extrusion unit 9 and the forming roll unit 10 are simultaneously moved along the rotation axes 15r, 16r and 17r.

The drawing shows the mode of the position adjustment mechanism 12 according to the first variation as an example. In this mode, the position adjustment mechanism 12 comprises a moving device and a support unit.

The moving device is configured to move the extrusion unit 9 along the rotation axes 15r, 16r and 17r. The moving device comprises a moving body and moving mechanism. As the moving body, for example, the extruder 20 provided in the extrusion unit 9 can be applied. The moving mechanism is configured to move the extruder (moving body) 20 in preset directions S1 and S2. Further, the moving mechanism comprises, for example, two guide rails 29, a plurality of rollers 30 and a controller (not shown).

The two guide rails 29 are arranged in parallel along the rotation axes 15r, 16r and 17r. The rollers 30 are rotatably provided in the extruder (moving body) 20. The rollers 30 are configured to roll along the guide rails 29. The controller is configured to control the rotating state (for example, the rotation direction, the rotation speed and the rotation number) of the rollers 30. A servomotor (not shown) which rotates the rollers 30 is mounted on the controller.

According to the moving device, the rollers 30 are driven and controlled by the controller. The rollers 30 can be thereby rolled along the guide rails 29. As a result, the extruder (moving body) 20 can be advanced and retreated in the directions of the arrows S1 and S2 in accordance with the rotational movement of the rollers 30. That is, it is possible, by advancing the extruder (moving body) 20 in the direction of the arrow S1, to bring the extruder (moving body) 20 close to the forming roll unit 10 along the rotation axes 15r, 16r and 17r. In contrast, it is possible, by retreating the extruder (moving body) 20 in the direction of the arrow S2, to separate the extruder (moving body) 20 from the forming roll unit 10 along the rotation axes 15r, 16r and 17r.

The support unit comprises a support body and a connection mechanism. The connection mechanism is configured to connect the support body to the extruder (moving body) 20. As the connection mechanism, for example, the connection pipe 22 provided in the extrusion unit 9 can be applied.

The support body is configured to support the slit 18. As the support body, for example, the T die 21 provided in the extrusion unit 9 can be applied. The T die 21 is provided with the slit 18. In other words, the slit 18 is supported by the T die 21. Here, the direction and position of the T die (support body) 21 are adjusted in a preset direction.

In the direction adjustment of the T die (support body) 21, for example, the direction of the long and thin rectangular discharge port 18c is adjusted to be parallel to the rotation axes 15r, 16r and 17r. The slit 18 is thereby supported parallel to the rotation axes 15r, 16r and 17r. As a result, the sheet-shaped molten resin 13a can be discharged from the slit 18 parallel to the rotation axes 15r, 16r and 17r.

In the position adjustment of the T die (support body) 21, the position of the discharge port 18c (slit 18) is matched with the position between the main roll 15 and the press roll 16. In other words, the discharge port 18c (slit 18) is positioned directly above the position between the main roll 15 and the press roll 16. In this way, the discharge port 18c (slit 18) is formed parallel to the rotation axes 15r, 16r and 17r and has a clearance (lip clearance H) having a constant size in the direction crossing the extrusion direction Fp. Consequently, the molten resin 13a can be supplied between the main roll 15 and the press roll 16 which are rotating, respectively.

In this structure, the T die (support body) which supports the slit 18 is connected to the extruder (moving body) 20 via the connection pipe (connection mechanism) 22. Here, the rollers 30 are rolled along the guide rails 29, for example, by the controller (servomotor). The extruder (moving body) 20 is advanced or retreated in the directions of the arrows S1 and S2. At this time, the forward and backward movements are transmitted to the T die (support body) 21 via the connection pipe (connection mechanism) 22. In this way, the T die (support body) 21 can be moved in accordance with the movement (advance and retreat) of the extruder (moving body) 20. As a result, the slit 18 can be moved parallel to the rotation axes 15r, 16r and 17r directly above the position between the main roll 15 and the press roll 16.

The position adjustment mechanism (not shown) according to the second variation and the third variation for moving the forming roll unit 10 along the rotation axes 15r, 16r and 17r has a moving mechanism (not shown) which moves the forming roll unit 10 along the rotation axes 15r, 16r and 17r. Similarly to the moving mechanism of the position adjustment mechanism 12 according to the first variation, this moving mechanism can move the forming roll unit 10 along the rotation axes 15r, 16r and 17r, for example, by rolling rollers provided in the forming roll unit 10 along guide rails.

“Position Adjustment of Neck-in Portions 13p”

The neck-in portions 13p are formed continuously in the extrusion direction Fp in the sheet-shaped molten resin 13a discharged from T die 21 (slit 18 and discharge port 18c). The neck-in portions 13p are formed at both edge portions (both side portions) of the molten resin 13a by a neck-in phenomenon.

The neck-in phenomenon is a phenomenon in which the sheet-shaped molten resin 13a discharged from the T die 21 is contracted and narrowed in the direction crossing the extrusion direction Fp (that is, the width direction of the slit 18), in other words, in the width direction of the sheet-shaped molten resin 13a. The contraction of the sheet-shaped molten resin 13a at this time occurs significantly at both end portions in the width direction, decreases toward the inside, and does not occur on the inside from specific positions. Accordingly, the thickness is large at both end portions of the sheet-shaped molten resin 13a in the width direction, the thickness decreases from both end portions to the specific positions corresponding to the end portions, and the thickness is a constant thickness (standard thickness) on the inside from the specific positions.

This neck-in phenomenon is considered to be caused by the action of the resultant force of the surface tension of the sheet-shaped molten resin 13a discharged from the T die 21, the melt elasticity characteristics and the tensile force of the sheet-shaped molten resin 13a in the extrusion direction Fp, and although the degree of contraction varies depending on the type of resin, this neck-in phenomenon occurs at all times.

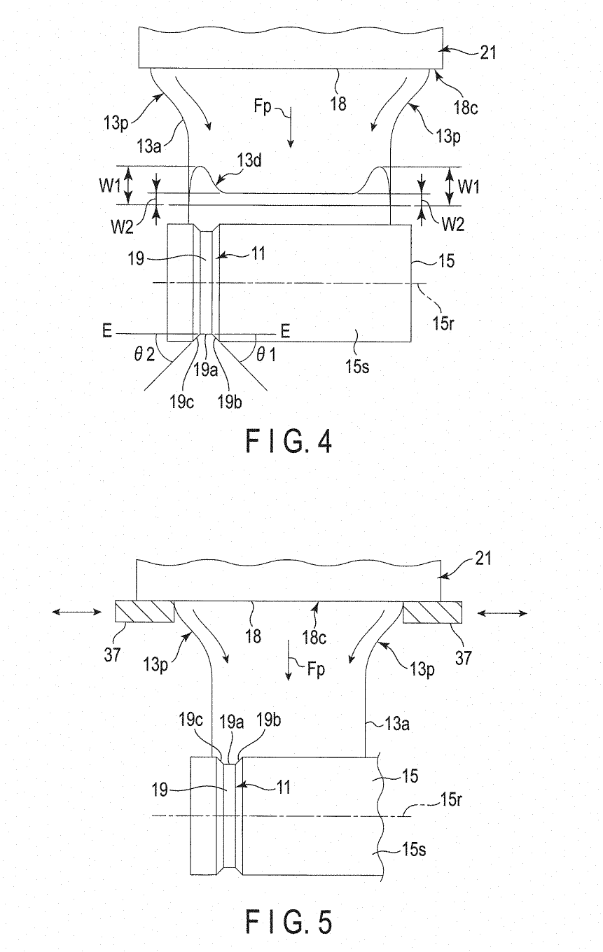

The neck-in portions 13p indicate both edge portions (both side portions) from both end portions in the width direction to the specific positions corresponding to the end portions, and indicate portions having a thickness greater than the constant thickness (standard thickness) of the sheet-shaped molten resin 13a located on the inside of the specific positions. In other words, the neck-in portions 13p are formed at both edge portions (both side portions) of the sheet-shaped molten resin 13a in the direction crossing the extrusion direction Fp. A thickness W1 of the neck-in portions 13p is greater than a thickness W2 of the portion (central portion or intermediate portion) other than both edge portions (both side portions) (see FIG. 4).

Since the neck-in portions 13p have a thickness greater than the standard thickness (constant thickness), conventionally, the neck-in portions 13p have not been used as a half-finished product or finished product. The neck-in portions 13p have been cut off and then discharged or recycled.

Here, the position adjustment mechanism 12 is configured to adjust the position of the slit 18 (discharge port 18c) and thereby position the neck-in portion 13p to be opposed to the thick portion forming groove 19. The thick portion forming groove 19 is continuously formed in the circumferential direction along one side of the main roll 15 (transfer surface 15s).

The thick portion forming groove 19 comprises a groove bottom surface 19a and two inclined surfaces (first inclined surface 19b and second inclined surface 19c). The bottom surface 19a is formed parallel to a horizontal direction E (direction along the rotation axis 15r), for example. The first and second inclined surfaces 19b and 19c are inclined from both sides of the groove bottom surface 19a toward the transfer surface 15s. The first and second inclined surfaces 19b and 19c have diverging gradients (inclination angles 81 and e2).

In this case, the portion formed by the first inclined surface 19b corresponds to the inclined surface 4 of the thin light guide plate 1 (see FIG. 7). It is necessary to set the inclined surface 4 at an optimum angle for propagating the light emitted from the light source 7 to the surface light emitting portion 3 without leakage. Therefore, the inclination angle 1i of the first inclined surface 19b is set in the range of 0°<θ1<30°.

Further, when the neck-in portion 13p and the thick portion forming groove 19 are aligned with each other, a rising portion 13d of the neck-in portion 13p should preferably be opposed to the first inclined surface 19b of the thick portion forming groove 19. The rising portion 13d is positioned near a boundary region between both edge portions (both side portions) in which the neck-in portions 13p are formed and the other portion (central portion or intermediate portion).

On the other hand, the second inclined surface 19c has a function as a stopper wall which holds the molten resin 13a in the thick portion forming groove 19. Therefore, the inclination angle θ2 of the second inclined surface 19c is not numerically limited in particular. The inclination angle θ2 can be any angle as long as the molten resin 13a will not flow out from the thick portion forming groove 19.

Even with the same resin, if the molecular weight grade is high, the viscosity becomes high, and the level of contraction of the sheet-shaped molten resin 13a by the neck-in phenomenon becomes low. In this case, it is conceivable that the volume of molten resin in the rising portion 13d of the neck-in portion 13p may be insufficient for the thick portion forming groove 19. As a countermeasure against this, for example, a groove having a depth of about 0.1 mm may be provided at a position corresponding to the rising portion 13d on the first slit surface 18a or the second slit surface 18b of the discharge slit 18, and the volume of molten resin discharged from the discharge slit 18 may be thereby increased only in that range.

“Optical Sheet Forming Method”

As shown in FIGS. 1 to 2 and 4, a molten resin is extruded from the extruder 20. By an extrusion pressure caused at this time, the molten resin is supplied from the connection pipe 22 to the T die 21.

The molten resin supplied to the T die 21 passes through the slit 18. At this time, the sheet-shaped molten resin 13a is discharged from the slit 18. The neck-in portions 13p are formed on both edge portions (both side portions) of the discharged molten resin 13a. The neck-in portion 13p is positioned to be opposed to the thick portion forming groove 19 by the position adjustment mechanism 12. In the positioning, it is possible to position the necked-in portion 13p to be opposed to the thick portion forming groove 19 while taking into consideration the extension amount of the connection pipe 22 due to thermal expansion. The initial setting is thereby completed. In this process, it is necessary to discharge the molten resin 13 experimentally.

Here, in place of the above-described initial setting process, another process may be applied. In this process, for example, the structure position of the neck-in portion 13p and the extension amount of the connection pipe 22 due to thermal expansion are predicted. Based on the predicted values, the neck-in portion 13p is positioned to be opposed to the thick portion forming groove 19 by the position adjustment mechanism 12. The initial setting is thereby completed. In this process, it is not necessary to discharge the molten resin 13 experimentally.

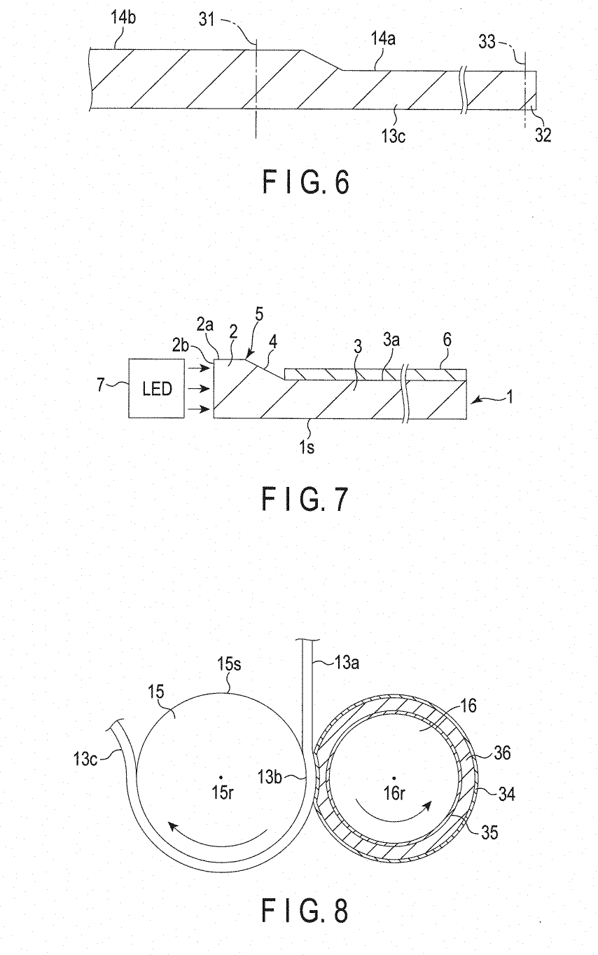

After the initial setting is completed, the sheet-shaped molten resin 13a is discharged from the slit 18. The discharged molten resin 13a passes (the contact point) between the main roll 15 and the press roll 16 while the discharge molten resin 13a is being compressed therebetween. At this time, the thick portion 14b conforming to the contour of the thick portion forming groove 19 is formed in the molten resin 13a. The thick portion 14b is thicker than the other portion and is continuously formed in the extrusion direction Fp. Subsequently, in a cutting process (see FIG. 6), the thick portion 14b is cut off along a preset cutting line 31. As a result, one half-finished product which leads to the thin light guide plate 1 is formed.

Next, in the half-finished product, a surplus portion 32 which is opposite to and is opposed to the thick portion 14b is cut off along a preset cutting line 33. Further, the half-finished product is cut out at a predetermined interval in the extrusion direction Fp. The thin light guide plate 1 integrally formed from the light incident portion 2 to the surface emitting portion 3 (see FIG. 7) is thereby formed.

Subsequently, in the thin light guide plate 1, various surface treatments are applied to a thin portion 14a which is to be the surface emitting portion 3. The thin light guide plate 1 as a finished product is thereby completed. After that, the light diffusing component 6 (for example, a diffusion sheet, a prism sheet, etc.) is mounted on the upper surface 3a of the surface emitting portion 3. The backlight unit of the mobile device (see FIG. 7) is thereby completed.

“Advantageous Effects of Embodiment”

According to the present embodiment, the extruder (moving body) 20 is advanced or retreated in the directions of the arrows S1 and S2 (directions parallel to the rotation axes 15r, 16r and 17r). At this time, the forward and backward movements are transmitted via the connection pipe (connection mechanism) 22 and move the T die (support body) 21. Accordingly, in the sheet-shaped molten resin 13a discharged from the T die 21 (slit 18 and discharge port 18c), the neck-in portion 13p is positioned to be opposed to the thick portion forming groove 19. The contour of the thick portion 14b of the half-finished product (the light incident portion 2 of the light guide plate 1) can be thereby accurately formed. As a result, the optical sheet used in the half-finished product (thin light guide plate 1) can be accurately extruded and formed in conformity with the counter of the preset shape.

Meanwhile, if the moving direction of the T die (support body) 21 is different from the connecting direction of the connection pipe (connection mechanism) 22 with respect to the T die (support body) 21, it is necessary to make the movement of the T die (support body) 21 in consideration of the extension amount of the connection pipe (connection mechanism) 22 due to thermal expansion, separately from the movement of the T die (support body) 21 for the positioning of the neck-in portion 13p to be opposed to the thick portion forming groove 19.

Therefore, according to the present embodiment, the moving direction of the T die (support body) 21 and the connecting direction of the connection pipe (connection mechanism) 22 with respect to the T die (support body) 21 are set to the same direction (for example, the direction parallel to the rotation axes 15r, 16r and 17r). Accordingly, it is possible, by simply moving the T die (support body) 21 in one direction, to position the neck-in portion 13p to be opposed to the thick portion forming groove 19 while taking into consideration the extension amount of the connection pipe 22 due to thermal expansion.

According to the present embodiment, one half-finished product which leads to the thin light guide plate 1 is formed in the direction crossing the extrusion direction Fp (that is, the width direction of the slit 18), in other words, in the width direction of the sheet-shaped molten resin 13a discharged from the T die 21. Therefore, the size of the T die (support body) 21 can be reduced. As a result, the structure of the position adjustment mechanism 12 can be simplified, and the entire apparatus can be made compact.

According to the present embodiment, in the contour of the half-finished product (the thin light guide plate 1), the upper surface 2a of the light incident portion 2 can be formed as a flat surface without recesses and projections. Accordingly, the light emitted from the light source 7 (for example, an LED) can be taken in from the light incident surface 2b without leakage and can be smoothly guided to the light incident portion 2. As a result, the half-finished product (thin light guide plate 1) having excellent light guide efficiency can be realized.

According to the present embodiment, the boundary portion 5 between the inclined surface 4 and the upper surface 2a of the light incident portion 2 can be made angular in the contour of the half-finished product (thin light guide plate 1). In other words, the boundary portion 5 between the inclined surface 4 and the upper surface 2a of the light incident portion 2 can be formed so as not to be rounded. In short, the angle can be steeply changed at the boundary portion 5 from the upper surface 2a of the light incident portion 2 toward the inclined surface 4. Therefore, the light guided to the light incident portion 2 can be propagated to the surface emitting portion 3 without leakage along the inclined surface 4. As a result, uniform light can be planarly generated from the surface emitting portion 3.

“Verification Test for Effects of Embodiment”

An invention mode in which the neck-in portion 13p is positioned to be opposed to the thick portion forming groove 19, and a conventional mode in which the neck-in portion 13p is not positioned to be opposed to the thick portion forming groove 19 are prepared.

Subsequently, a common testing device (that is, the optical sheet forming apparatus 8) is prepared for both modes.

The specifications of the testing device are as follows.

Extruder: Co-rotating twin-screw kneading extruder, Screw nominal diameter 28 mm

T die: Width 330 mm, Lip clearance 0.8 mm

Three rolls: Diameter 180 mm, Long side length 400 mm

Main roll: Groove of depth of 0.15 mm on one side

Extrusion volume (flow rate) of molten resin: 20 kg/h, Polycarbonate material

Thickness of finished product (light guide plate): Thickness of thick portion (light incident portion) 0.35 mm, Thickness of thin portion (surface emitting portion) 0.2 mm

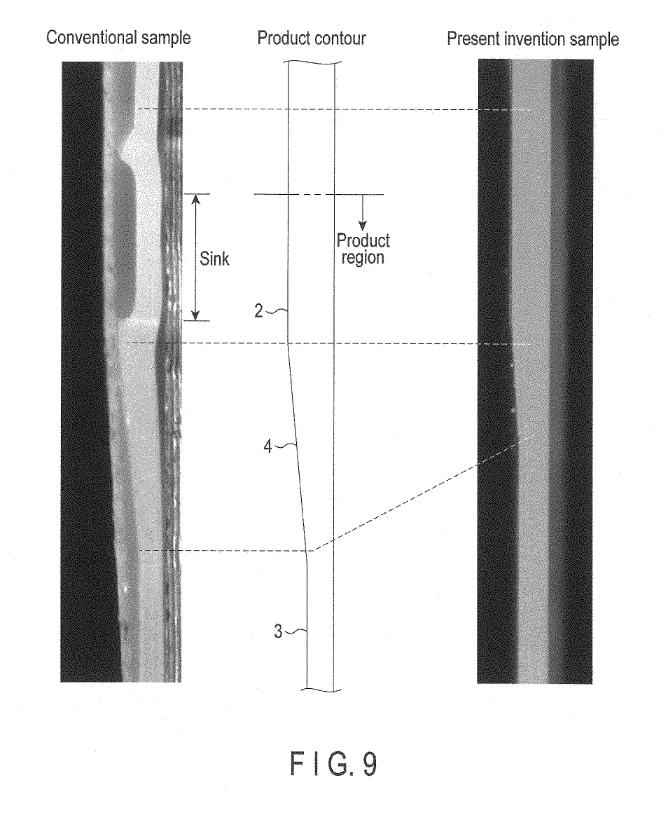

FIG. 9 shows a test result. That is, a cross-sectional photographic image of a half-finished product obtained according to the invention mode (present invention sample) and a cross-sectional photographic image of a half-finished product obtained according to the conventional mode (conventional sample) are shown. An optical product contour is shown between both cross-sectional photographic images. According to the test result, in a product region having the product contour, “sink” occurs in the half-finished product of the conventional mode, whereas “sink” does not occur in the half-finished product of the invention mode. The result verifies the above-described advantageous effects.

“Modification”

In the above-described embodiment, the press roll (first roll) 16 of the forming roll unit 10 is assumed to have an outer periphery which is not elastically deformed. Instead, the press roll 16 having an elastically-deformable outer periphery may be applied. As shown in FIG. 8, the press roll 16 of the present modification comprises an outer cylinder 34, an inner cylinder 35 and a temperature control medium 36. The outer cylinder 34 is arranged outside the inner cylinder 35. The temperature control medium 36 fills or circulates between the outer cylinder 34 and the inner cylinder 35 without space therebetween. The outer cylinder 34 and the inner cylinder 35 are provided concentrically with respect to the rotation axis 16r of the press roll 16.

The inner cylinder 35 has rigidity. The inner cylinder 35 is less likely to be elastically deformed. The inner cylinder 35 is formed of a metal material. On the other hand, the outer cylinder 34 has elasticity. The outer cylinder 34 is configured to be elastically deformed. The outer cylinder 34 is formed of a metal material. In this case, the outer cylinder 34 is thinner than the inner cylinder 35. Since the outer cylinder 34 is made thin, the outer cylinder 34 is more likely to be elastically deformed.

According to this structure, when the sheet-shaped molten resin 13a discharged from the slit 18 of the T die 21 is pressed against the transfer surface 15s of the main roll (second roll) 15, the outer cylinder 34 is elastically deformed along the transfer surface 15s. Therefore, the molten resin 13a can be brought into close contact with the thick portion forming groove 19 of the main roll 15 without space. As a result, the molten resin 13a can be pressed uniformly over the entire width of the transfer surface 15s of the main roll 15.

In this case, a portion of the outer cylinder 34 which is in contact with the molten resin 13a should preferably be mirror-finished. The lower surface is of the half-finished product (thin light guide plate 1) can be thereby formed as a smooth and flat surface. The lower surface is of the half-finished product (thin light guide plate 1) can be opposed parallel to the upper surface 2a of the light incident portion 2 and the upper surface 3a of the surface emitting portion 3. As a result, the optical characteristics of the thin light guide plate 1 as a half-finished product can be maintained constant. Since structures and advantageous effects other than those described above are similar to those of the above-described embodiment, detailed description thereof will be omitted.

“Modification”

In the above-described embodiment, at the time of the initial setting, in the case of further performing the position adjustment of the neck-in portion 13p after the initial setting, for example, as shown in FIG. 5, the slit 18 (discharge port 18c) of the T die 21 may be limited by a deckle 37. The deckle 37 can be set so as to partially cover the slit 18 (discharge port 18c). As a result, the discharge range of the molten resin 13a can be narrowed or expanded and can be adjusted according to intended purpose and use. Accordingly, for example, the neck-in portion 13p and the thick portion forming groove 19 can be aligned with each other with high accuracy. As a result, an optical sheet having high quality and accuracy can be formed. Since structures and advantageous effects other than those described above are similar to those of the above-described embodiment, detailed description thereof will be omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical sheet forming apparatus comprising:
an extrusion unit having a discharge slit configured to discharge a sheet-shaped molten resin;
a forming roll unit having a roll configured to rotate about a rotation axis arranged in a direction crossing an extrusion direction so as to convey the discharged molten resin in the extrusion direction while solidifying the discharged molten resin;
a thick portion forming groove provided in the forming roll unit and configured to form a thick portion which is thicker than other portion continuously in the extrusion direction in a part of the molten resin; and
a position adjustment mechanism configured to adjust a position of the discharge slit with respect to the thick portion forming groove, wherein
a neck-in portion caused by a neck-in phenomenon is formed continuously in the extrusion direction in the molten resin discharged from the discharge slit, and
the neck-in portion is positioned to be opposed to the thick portion forming groove by the adjustment of the position of the discharge slit with respect to the thick portion forming groove by the position adjustment mechanism.

2. The optical sheet forming apparatus of claim 1, wherein
the position adjustment mechanism comprises;
a moving device configured to move the extrusion unit along the rotation axis; and
a support unit configured to support the discharge slit in parallel along the rotation axis such that the sheet-shaped molten resin is discharged in parallel along the rotation axis from the discharge slit, and
the position adjustment mechanism moves the extrusion unit and thereby moves the discharge slit in parallel along the rotation axis.

3. The optical sheet forming apparatus of claim 2, wherein
the moving device comprises:
a moving body provided in the extrusion unit; and
a moving mechanism configured to move the moving body in a preset direction, and
the support unit comprises:
a support body provided in the extrusion unit and configured to support the discharge slit; and
a connection mechanism configured to connect the support body to the moving body, wherein
the moving device moves the support body in accordance with the movement of the moving body, and thereby moves the discharge slit in parallel along the rotation axis.

4. The optical sheet forming apparatus of claim 1, wherein
the position adjustment mechanism comprises a moving mechanism configured to move the forming roll unit along the rotation axis, and
the position adjustment mechanism moves the forming roll unit by the moving mechanism, and thereby moves the thick portion forming groove in parallel along the rotation axis.

5. The optical sheet forming apparatus of claim 1, wherein
the position adjustment mechanism comprises a deckle configured to cover a part of the discharge slit, and
the position adjustment mechanism limits the discharge slit by the deckle, and thereby adjusts a discharge range of the molten resin.

6. An optical sheet forming method using the optical sheet forming apparatus of one of claim 1, comprising:
discharging the sheet-shaped molten resin from the discharge slit of the extrusion unit;
conveying the discharge molten resin in the extrusion direction while solidifying the discharge molten resin by the forming roll unit;
forming the thick portion which is thicker than other portion continuously in the extrusion direction in the part of the molten resin by the thick portion forming groove; and
adjusting the position of the discharge slit with respect to the thick portion forming groove by the position adjustment mechanism, wherein
the neck-in portion caused by the neck-in phenomenon is formed continuously in the extrusion direction in the discharged molten resin, and
the neck-in portion is positioned to be opposed to the thick portion forming groove by the adjustment of the position of the discharge slit with respect to the thick portion forming groove by the position adjustment mechanism.

7. An optical sheet forming method using the optical sheet forming apparatus of one of claim 2, comprising:
discharging the sheet-shaped molten resin from the discharge slit of the extrusion unit;
conveying the discharge molten resin in the extrusion direction while solidifying the discharge molten resin by the forming roll unit;
forming the thick portion which is thicker than other portion continuously in the extrusion direction in the part of the molten resin by the thick portion forming groove; and
adjusting the position of the discharge slit with respect to the thick portion forming groove by the position adjustment mechanism, wherein
the neck-in portion caused by the neck-in phenomenon is formed continuously in the extrusion direction in the discharged molten resin, and
the neck-in portion is positioned to be opposed to the thick portion forming groove by the adjustment of the position of the discharge slit with respect to the thick portion forming groove by the position adjustment mechanism.

8. An optical sheet forming method using the optical sheet forming apparatus of one of claim 3, comprising:
discharging the sheet-shaped molten resin from the discharge slit of the extrusion unit;
conveying the discharge molten resin in the extrusion direction while solidifying the discharge molten resin by the forming roll unit;
forming the thick portion which is thicker than other portion continuously in the extrusion direction in the part of the molten resin by the thick portion forming groove; and
adjusting the position of the discharge slit with respect to the thick portion forming groove by the position adjustment mechanism, wherein
the neck-in portion caused by the neck-in phenomenon is formed continuously in the extrusion direction in the discharged molten resin, and
the neck-in portion is positioned to be opposed to the thick portion forming groove by the adjustment of the position of the discharge slit with respect to the thick portion forming groove by the position adjustment mechanism.

9. An optical sheet forming method using the optical sheet forming apparatus of one of claim 4, comprising:
discharging the sheet-shaped molten resin from the discharge slit of the extrusion unit;
conveying the discharge molten resin in the extrusion direction while solidifying the discharge molten resin by the forming roll unit;
forming the thick portion which is thicker than other portion continuously in the extrusion direction in the part of the molten resin by the thick portion forming groove; and
adjusting the position of the discharge slit with respect to the thick portion forming groove by the position adjustment mechanism, wherein
the neck-in portion caused by the neck-in phenomenon is formed continuously in the extrusion direction in the discharged molten resin, and
the neck-in portion is positioned to be opposed to the thick portion forming groove by the adjustment of the position of the discharge slit with respect to the thick portion forming groove by the position adjustment mechanism.

10. An optical sheet forming method using the optical sheet forming apparatus of one of claim 5, comprising:
discharging the sheet-shaped molten resin from the discharge slit of the extrusion unit;
conveying the discharge molten resin in the extrusion direction while solidifying the discharge molten resin by the forming roll unit;
forming the thick portion which is thicker than other portion continuously in the extrusion direction in the part of the molten resin by the thick portion forming groove; and
adjusting the position of the discharge slit with respect to the thick portion forming groove by the position adjustment mechanism, wherein
the neck-in portion caused by the neck-in phenomenon is formed continuously in the extrusion direction in the discharged molten resin, and
the neck-in portion is positioned to be opposed to the thick portion forming groove by the adjustment of the position of the discharge slit with respect to the thick portion forming groove by the position adjustment mechanism.

11. The optical sheet forming method of claim 6, further comprising:
cutting off the thick portion along the thick portion; and
cutting off a surplus portion which is opposite to and is opposed to the thick portion.
